(19) United States
(12) Patent Application Publication
(10) Pub. No.: US 2021/0154737 A1
(43) Pub. Date: May 27, 2021

(54) THREE-DIMENSIONAL PRINTING ALLOY POWDER

(71) Applicant: SEIKO EPSON CORPORATION, Tokyo (JP)

(72) Inventors: Toshiki SANO, Hachinohe-shi (JP); Hidefumi NAKAMURA, Hachinohe-shi (JP); Atsushi NAKAMURA, Hachinohe-shi (JP)

(21) Appl. No.: 17/105,257

(22) Filed: Nov. 25, 2020

(30) Foreign Application Priority Data
Nov. 27, 2019 (JP) 2019-214114

(51) Int. Cl. B22F 1/02; B22F 1/00; B33Y 70/00

(52) U.S. Cl. CPC B22F 1/02; B22F 1/0018; B33Y 70/00; B22F 2304/10; B22F 2301/35; B22F 2302/40; B22F 2304/054

(57) ABSTRACT

A three-dimensional printing alloy powder includes iron alloy powder, wherein a coating layer containing a carbon material is formed at surfaces of the iron alloy powder, the iron alloy powder contain oxygen atoms at a concentration of 0.1 mass % or more and 0.7 mass % or less with respect to the total amount of the iron alloy powder, a mass y g of the carbon material contained per 100 g of the three-dimensional printing alloy powder has a relationship with a mass x g of the oxygen atoms and a corrected mass z g represented by the following formula: y=0.75×x−z, and the corrected mass z exceeds 0.0 g and is smaller than 0.4 g.

The present application is based on, and claims priority from JP Application Serial Number 2019-214114, filed on Nov. 27, 2019, the disclosure of which is hereby incorporated by reference herein in its entirety.

### BACKGROUND

### 1. Technical Field

The present disclosure relates to a three-dimensional printing alloy powder.

### 2. Related Art

Heretofore, there has been known an alloy powder produced by a water atomization method. In the water atomization method, for example, as compared with a gas atomization method or the like, a powder to be produced is made finer, but an oxide is likely to be generated at particle surfaces of the powder due to a reaction between a molten metal with water that is an atomizing medium. Therefore, when the powder is used for three-dimensional printing, the density or the surface smoothness, and the mechanical property or the fatigue strength in a printed object are sometimes deteriorated by the oxide.

For example, in JP-A-2017-110294 (Patent Document 1), a raw material powder treatment method in which a raw material powder is subjected to a plasma treatment for decreasing an oxide or the like at a surface of the raw material powder is proposed.

However, the raw material powder treatment method described in Patent Document 1 has a problem that it is difficult to remove the oxide at the particle surfaces of the powder. More specifically, the plasma treatment is performed after a thin layer is formed for the powder, and therefore, it is difficult to remove the oxide at the surface of the powder which is not exposed at the surface of the thin layer.

### SUMMARY

A three-dimensional printing alloy powder is a three-dimensional printing alloy powder including iron alloy powder, wherein a coating layer containing a carbon material is formed at surfaces of the iron alloy powder, the iron alloy powder contain oxygen atoms at a concentration of 0.1 mass % or more and 0.7 mass % or less with respect to the total amount of the iron alloy powder, a mass y g of the carbon material contained per 100 g of the three-dimensional printing alloy powder has a relationship with a mass x g of the oxygen atoms and a corrected mass z g represented by the following formula: y=0.75×x−z, and the corrected mass z exceeds 0.0 g and is smaller than 0.4 g.

### BRIEF DESCRIPTION OF THE DRAWINGS

FIG. 1 is a schematic cross-sectional view showing one particle of a three-dimensional printing alloy powder according to a first embodiment.

FIG. 2 is a process flow diagram showing a production method for a three-dimensional printing alloy powder.

FIG. 3 is a schematic cross-sectional view showing one particle of a three-dimensional printing alloy powder according to a second embodiment.

### DESCRIPTION OF EXEMPLARY EMBODIMENTS

### 1. First Embodiment

### 1.1. Three-Dimensional Printing Alloy Powder

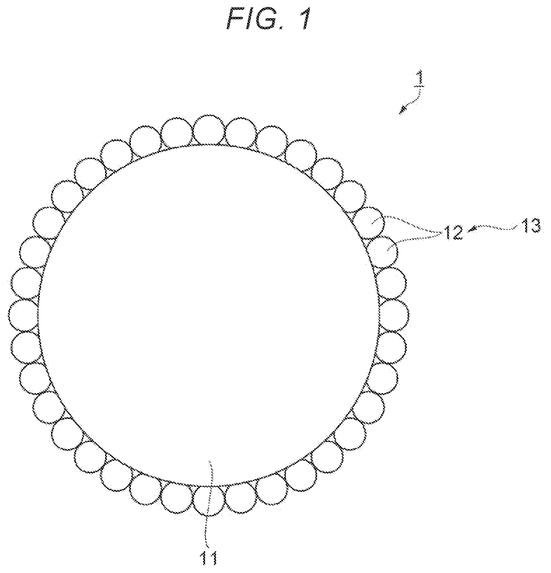

A configuration of a three-dimensional printing alloy powder according to a first embodiment will be described with reference to FIG. 1. Note that in the following respective drawings, for the sake of convenience of illustration, the shapes of particles or the scales of the respective members are made different from the actual ones.

As shown in FIG. 1, a three-dimensional printing alloy powder 1 of this embodiment includes iron alloy powder 11. The iron alloy powder 11 are formed by the below-mentioned water atomization method. At a surface of each iron alloy powder 11, a coating layer 13 containing a carbon material 12 is formed. That is, to the surface of the iron alloy powder 11, a plurality of carbon materials 12 adhere, and the surface is coated with the coating layer 13. Here, in the following description, the three-dimensional printing alloy powder 1 is sometimes simply referred to as “alloy powder 1”.

The alloy powder 1 is used for a forming material of a three-dimensional printed article. A production method for the three-dimensional printed article is not particularly limited, but for example, known methods such as a binder jetting (BJ) method, a fused deposition modeling (FDM) method, a laser deposition (LMD) method, and a laser melting (SLM) method are exemplified. In particular, for the three-dimensional printing alloy powder according to the present disclosure, a BJ method and an FDM method are preferred among these.

### 1.1.1. Iron Alloy Powder

The iron alloy powder 11 is not particularly limited as long as it is an alloy containing iron and has sinterability. Examples of a forming material of the iron alloy powder 11 include stainless steels such as austenitic stainless steels, martensitic stainless steels, and precipitation hardening stainless steels, low carbon steels, carbon steels, heat-resistant steels, die steels, high-speed tool steels, Fe—Ni alloys, and Fe—Ni—Co alloys.

Further, as the forming material of the iron alloy particle 11, pure iron, a magnetic alloy such as an Fe-Si-based alloy such as a silicon steel, an Fe-Ni-based alloy such as permalloy, an Fe-Co-based alloy such as permendur, an Fe-Si-Al-based alloy such as Sendust, an Fe-Cr-Si-based alloy, or an Fe-Cr-Al-based alloy may be used.

The iron alloy powder 11 is produced by a water atomization method. By adopting the water atomization method for the production of the iron alloy powder 11, as compared with a gas atomization method or the like, a powder having a small average particle diameter can be produced at low cost. In the water atomization method, by a reaction of a molten metal of the forming material of the iron alloy powder 11 with water as the atomizing medium, an oxide film (not shown) is generated at the surface of the iron alloy powder 11. Further, there is a case where an oxide is generated by the water atomization method from an impurity of a component contained in the iron alloy powder 11 or an impurity mixed in the production process or the like. For example, when silicon is contained in the forming material of the iron alloy powder 11, silicon oxide is sometimes generated. The production method for the iron alloy powder 11 is not limited to the water atomization method, and may be, for example, a spinning water atomization method in which a molten metal is gas-atomized to a spinning water stream, or the like.

The iron alloy powder 11 of this embodiment has an oxide including the above-mentioned oxide film and an oxide derived from an impurity contained in the iron alloy powder 11. The content of the oxide contained in the iron alloy powder 11 depends on the magnitude of the average particle diameter of the iron alloy powder 11 or the forming material thereof, or the like. Specifically, the iron alloy powder 11 contains oxygen atoms mainly derived from the oxide at a concentration of 0.1 mass % or more and 0.7 mass % or less with respect to the total amount of the iron alloy powder 11.

In the related art, the density or the surface smoothness in a three-dimensional printed article is sometimes deteriorated by the oxide. In the present disclosure, in a firing step in the production of a three-dimensional printed article, the oxide can be removed by reduction with a carbon material such as the carbon material 12. Therefore, the density or the surface smoothness of the three-dimensional printed article is improved as compared with the related art. That is, the present disclosure is preferred for the iron alloy powder 11 produced by the water atomization method.

The shape of the iron alloy powder 11 is not limited to a substantially spherical shape, and may be, for example, an irregular shape having a plurality of projections at the surface. The average particle diameter of the iron alloy powder 11 is 0.1 μm or more and 20.0 μm or less, preferably 0.5 μm or more and 15.0 μm or less. The average particle diameter of the iron alloy powder 11 can be adjusted by a dropping amount per unit time of the molten metal in the production process for the iron alloy powder 11, the pressure or the flow rate of water as the atomizing medium, or the like. Further, classification may be performed for adjusting the average particle diameter of the iron alloy powder 11.

The average particle diameter as used herein refers to a volume-based particle size distribution (50%). The average particle diameter is measured by a dynamic light scattering method or a laser diffraction method described in JIS Z 8825. Specifically, for example, a particle size distribution meter using a dynamic light scattering method as a measurement principle can be adopted.

The iron alloy powder 11 may contain an additive other than the above-mentioned forming material or an impurity. Examples of the additive include various types of metals, various types of non-metals, and various types of metal oxides.

### 1.1.2. Carbon Material

The carbon material 12 adheres to the surface of the iron alloy powder 11 and forms the coating layer 13. Examples of a forming material of the carbon material 12 include graphite, carbon black, activated carbon, carbon fibers, carbon nanotubes, and carbon nanoparticles, and one or more types among these are used as the forming material of the carbon material 12. As the carbon material 12, a commercially available product may be used. A method for forming the coating layer 13 for the iron alloy powder 11, that is, a production method for the alloy powder 1 will be described later.

The shape of the carbon material 12 is not particularly limited, but is preferably a particulate shape from the viewpoint of improving the coatability for the surface of the iron alloy powder 11. The average particle diameter of the carbon material 12 is 3 nm or more and 100 nm or less, preferably 5 nm or more and 50 nm or less, more preferably 10 nm or more and 30 nm or less. According to this, the average particle diameter of the carbon material 12 is relatively fine, and therefore, in the production process for the alloy powder 1, the dispersibility and the coatability of the carbon material 12 with respect to the iron alloy powder 11 are improved. Therefore, the carbon material 12 can be relatively evenly adhered or stuck to the surface of the iron alloy powder 11. The average particle diameter of the carbon material 12 can be measured in the same manner as the average particle diameter of the iron alloy powder 11 described above.

A mass y g of the carbon material 12 contained per 100 g of the alloy powder 1 has a relationship with a mass x g of the oxygen atoms and a corrected mass z g represented by the following formula: y=0.75×x−z.

When an FDM method, a BJ method, or the like is adopted for the production of a three-dimensional printed object, a binder is used. In the FDM method, molding is performed by extruding a mixture containing the alloy powder 1 and a binder from a nozzle. In the BJ method, after a layer of the alloy powder 1 is formed, the layer is impregnated with a solution containing a binder so as to bind the particles of the alloy powder 1 to one another. By repeatedly performing this operation, a three-dimensional molded body is obtained. In view of such an application, as the binder, an organic compound such as a resin or an adhesive is preferred.

A forming material of the binder is not particularly limited, but for example, an acrylonitrile-butadiene-styrene resin, polylactic acid, polyvinyl alcohol, a phenolic resin, an acrylic adhesive, a silicone-based adhesive, or the like is exemplified.

The coefficient: 0.75 of x in the above formula is a value obtained by dividing the atomic weight of carbon by the atomic weight of oxygen. The corrected mass z is the carbon content derived from the binder to be added to the alloy powder 1. That is, the oxide included in the iron alloy powder 11 is reduced by the carbon material 12 in the coating layer 13 and the carbon content derived from the binder in the firing step when producing a three-dimensional printed object. More specifically, an oxygen atom contained in the oxide is bound to a carbon atom of the carbon material 12 or the like in an equimolar amount to form carbon monoxide and is removed. That is, according to the above formula, carbon enough for reducing the oxide included in the iron alloy powder 11 is ensured.

In the production of a three-dimensional printed object, most of the binder used for the production of the molded body is thermally decomposed by heating in a degreasing treatment to be performed before the firing step and released. Although not being particularly limited, the carbon content derived from the binder remaining after the heating treatment such as the degreasing treatment with respect to the content of the binder contained in the molded body is about 5 mass % or so.

In the production of a three-dimensional printed object by an FDM method or the like, for example, the amount of the binder to be used for the production of the molded body is less than 8 mass % with respect to the total amount of the alloy powder 1. Therefore, when the total amount of the alloy powder 1 is assumed to be 100 g, the carbon content derived from the residual binder is less than 0.4 g. That is, the corrected mass z exceeds 0.0 g and is smaller than 0.4 g.

In the production of a three-dimensional printed object by a BJ method, for example, the binder to be used for the production of the molded body is less than 1 mass % with respect to the total amount of the alloy powder 1. Therefore, when the total amount of the alloy powder 1 is assumed to be 100 g, the carbon content derived from the residual binder is less than 0.05 g. That is, when a BJ method is used, it is preferred that the corrected mass z exceeds 0.00 g and is smaller than 0.05 g.

The alloy powder 1 may contain an inorganic powder such as a ceramic powder or a glass powder, or an additive such as a plasticizer, a lubricant, an antioxidant, a degreasing accelerator, or a surfactant other than the above-mentioned components.

### 1.2. Production Method for Alloy Powder

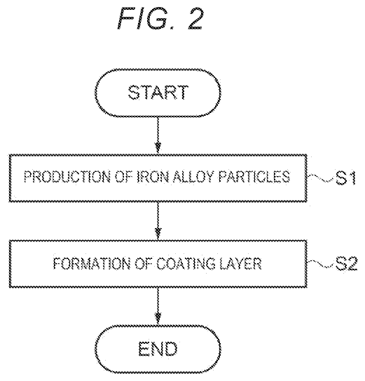

A production method for the alloy powder 1 will be described with reference to FIG. 2. As shown in FIG. 2, the production method for the alloy powder 1 of this embodiment includes Step S1 and Step S2. Note that the process flow shown in FIG. 2 is an example, and is not limited thereto.

In Step S1, the iron alloy powder 11 are produced by a water atomization method. In the production of the iron alloy powder 11, a known atomizer may be used. The atomizer is not particularly limited, but for example, it includes a tundish that is a molten metal supply portion, a nozzle disposed below the tundish, and a cylindrical member disposed between the tundish and the nozzle.

First, by using a high-frequency induction furnace or the like, the forming material of the iron alloy powder 11 is melted by heating to form a molten metal. Subsequently, the molten metal is supplied to the tundish of the atomizer. The molten metal is temporarily stored in the tundish, and thereafter dropped by the force of gravity toward the nozzle at a lower part through the cylindrical member from an ejection port at the bottom of the tundish. To the dropped molten metal, high-pressure water that is anatomizing medium is sprayed from the nozzle. By doing this, the molten metal is scattered and transformed into fine molten metal droplets, and also solidified through heat absorption by water, whereby solid particles are formed. At that time, the above-mentioned oxide is generated at the particles. The particles are dropped and accumulated below the nozzle by the force of gravity. The obtained particles are appropriately subjected to classification, whereby the iron alloy powder 11 are formed.

In Step S2, the coating layer 13 is formed for the iron alloy powder 11. In this embodiment, in the formation of the coating layer 13, a mixing treatment is performed for the iron alloy powder 11 and the carbon material 12. The mixing treatment as used herein refers to a treatment method in which physical stress is hardly applied to the iron alloy powder 11 and the carbon material 12 to be mixed. As an apparatus for the mixing treatment, for example, a container rotary-type mixer such as a V-type mixer or a W-type mixer, a mixer including a stirring blade, a mixer having a vibration mechanism such as an ultrasonic homogenizer, or the like is exemplified.

By using the above apparatus, the iron alloy powder 11 and the carbon material 12 are mixed while stirring. In the mixing treatment, heat is sometimes generated by interparticle friction of the iron alloy powder 11 and the carbon material 12. Therefore, the mixing treatment is preferably performed in an inert gas atmosphere.

The mixing ratio of the iron alloy powder 11 and the carbon material 12 is determined according to the formula of the mass y of the carbon material contained per 100 g of the alloy powder 1 described above. Specifically, for example, the mass x of the oxygen atoms can be found by an elemental analysis using a wavelength dispersive X-ray analyzer, or the like. The corrected mass z can be calculated from the used amount of the binder to be used according to the production method for a three-dimensional printed object to which the alloy powder 1 is applied.

By the mixing treatment, the carbon material 12 adheres to the surfaces of the iron alloy powder 11 to form the coating layer 13, whereby the alloy powder 1 is obtained. Note that the carbon material 12 which did not adhere to the iron alloy powder 11 may be removed by classification or the like or may be kept contained in the alloy powder 1.

The coating layer 13 in the alloy powder 1 can be confirmed by quantitative determination of the carbon content using a thermogravimetry-differential thermal analyzer in addition to observation using an electron microscope or the like. Specifically, the alloy powder 1 is heated to about 600° C. in a nitrogen atmosphere, and thereafter, the temperature is once lowered to 400° C. Then, the atmosphere is changed to an air atmosphere, and the alloy powder 1 is heated to about 800° C. The mass decrement in this air atmosphere is the carbon content of the coating layer 13. Note that when carbon is contained in the iron alloy powder 11, a quantitative analysis of the carbon content of the iron alloy powder 11 alone before forming the coating layer 13 is performed, and the carbon content may be subtracted.

In this embodiment, as the method for forming the coating layer 13, the mixing treatment is shown as an example, however, it is not limited thereto. In the formation of the coating layer 13, a mechanical method for sticking the carbon material 12 to the iron alloy powder 11 by physical stress may be used.

### 1.3. Production Method for Three-Dimensional Printed Object

In the production method for a three-dimensional printed object using the alloy powder 1, the above-mentioned known method can be adopted. The production method for a three-dimensional printed object includes, for example, a molding step of producing a molded body by three-dimensional printing, a firing step of forming a sintered body by subjecting the molded body to a firing treatment, and a polishing step of polishing the surface of the sintered body. In this embodiment, the firing step in the production method for a three-dimensional printed object will be described.

Prior to the firing step, the binder contained in the molded body is partially removed by performing the above-mentioned degreasing treatment. Specifically, for example, the molded body is heated at a temperature of 100° C. or higher and 750° C. or lower for a time within a range of about 0.1 hours to about 20 hours. The atmosphere during the degreasing treatment is set to an atmospheric atmosphere, an inert gas atmosphere, a depressurized atmosphere, or the like. The degreasing treatment may be incorporated in the firing step as one step of a firing pattern. Note that the oxide contained in the alloy powder 1 also includes an oxide mixed in the molding step, the degreasing step, or the like in addition to the oxide film of the iron alloy powder 11 and the oxide derived from the component described above.

In the firing step, by a multistage heating temperature pattern, reduction of the oxide in the alloy powder 1 and sintering of the molded body by firing are performed. First, in order to reduce the oxide, for example, the molded body is heated at a temperature of 1000° C. or higher and 1050° C. or lower for a time within a range of about 1 hour to about 3 hours. The atmosphere to which the molded body is exposed at that time is set to, for example, a depressurized atmosphere in which air, an inert gas, or the like is depressurized, or a reducing gas atmosphere of hydrogen gas, ammonia cracking gas, or the like.

Among these atmospheres, it is preferred to adopt a depressurized atmosphere as the atmosphere to which the molded body is exposed. In the depressurized atmosphere, the oxygen concentration in the atmosphere is reduced by depressurization, and therefore, the equilibrium oxygen concentration is low. Accordingly, the reduction of the oxide is accelerated. Further, when air is used for the depressurized atmosphere, the atmosphere can be easily prepared using an exhaust pump or the like without particularly controlling the atmosphere before depressurization. Further, since the atmosphere is depressurized, a product such as carbon monoxide by an oxidation-reduction reaction is easily removed by exhausting the gas, and an adverse effect of carbon monoxide or the like on the three-dimensional printed object is suppressed.

The degree of vacuum of the depressurized atmosphere is not particularly limited, but for example, is preferably 0.001 Pa or more and 1.0 kPa or less, more preferably 0.001 Pa or more and 100 Pa or less. According to this, the reduction of the oxide in the depressurized atmosphere is accelerated.

The oxide included in the alloy powder 1 is reduced by the carbon material 12 in the above-mentioned heating, and at least partially converted into carbon monoxide and removed. The carbon material 12 of the coating layer 13 coats the surfaces of the iron alloy powder 11 constituting the molded body. Therefore, the carbon material 12 and the oxide included in the iron alloy powder 11 are located near to each other, and the oxidation-reduction reaction of the oxide and the carbon material 12 promptly proceeds. Accordingly, the oxide can be easily removed.

In the forming material of the iron alloy powder 11, a metal element or a nonmetal element such as silicon is contained as an impurity. In particular, when silicon is contained as an impurity, silicon oxide may be sometimes generated and deposited by a water atomization method. Silicon oxide has become a factor to decrease the metallic luster of the three-dimensional printed object. According to the present disclosure, such silicon oxide is also reduced, and therefore, the luster of the three-dimensional printed object can be improved.

Subsequently, in order to form a sintered body by firing the molded body, for example, the molded body is heated at a temperature of 980° C. or higher and 1600° C. or lower for a time within a range of about 0.2 hours to about 7 hours. The atmosphere to which the molded body is exposed at that time is set to, for example, an atmospheric atmosphere, an inert gas atmosphere, a depressurized atmosphere, or the like. According to this, the molded body is fired, whereby a sintered body is formed. In the degreasing treatment and the firing step, a high-temperature furnace such as a muffle furnace is used for heating the molded body.

Subsequently, the sintered body is subjected to a polishing step or the like, whereby a three-dimensional printed object is formed. Examples of the application of the three-dimensional printed object include parts for watch cases such as a case body, a case back, and a one-piece case in which a case body and a case back are integrated, parts for watch bands such as a band clasp and a band-bangle attachment mechanism, bezels such as a rotatable bezel, parts for crowns such as a screw-lock crown, exterior parts for watches such as a button, a glass frame, a dial ring, an etching plate, and a packing, parts for eyeglasses such as an eyeglass frame, personal ornaments such as a belt buckle, a tie clip, a cuff button, a ring, a necklace, a bracelet, an anklet, a brooch, a pendant, earrings, and pierced earrings, tableware such as a spoon, a fork, chopsticks, a knife, abutter knife, and a bottle opener, a lighter or a lighter case, sports goods such as a golf club, a nameplate, a panel, a prize cup, a molding die, a machine part, a magnetic circuit part, and other housings. Examples such other housings include housings for cellular phones, smartphones, tablet terminals, mobile computers, music players, cameras, shavers, and the like.

According to this embodiment, the following effects can be obtained.

The oxide contained in the alloy powder 1 can be easily removed. More specifically, the oxide includes the oxide film and an oxide of silicon or the like derived from the component of the iron alloy powder 11 generated by a water atomization method. On the other hand, in the firing step for producing a three-dimensional printed object from the alloy powder 1, the oxide is reduced by the carbon material 12, and oxygen is bound to carbon to form carbon monoxide and is eliminated. In particular, the carbon material 12 is contained in the coating layer 13 and coats the surface of the iron alloy powder 11. Therefore, as compared with the treatment method in the related art, the reducing reaction can be exhibited throughout the oxide.

When silicon is contained in the iron alloy powder 11, silicon oxide generated by a water atomization method is reduced and remains as a solid solution of iron and silicon. Accordingly, sintering of the alloy powder 1 is accelerated, and the density of the three-dimensional shaped article is increased, and thus, the strength or the smoothness when the surface is polished in the three-dimensional printed object can be improved.

The corrected mass z exceeds 0.00 g and is smaller than 0.05 g, and therefore, for example, as in the case of the BJ method, when the used amount of the binder with respect to the alloy powder 1 is less than 1 mass %, and the carbon content derived from the binder is less than 5 mass %, carbon enough for reducing the oxide can be ensured.

The average particle diameter of the iron alloy powder 11 is 0.1 μm or more and 20.0 μm or less, and the average particle diameter is relatively small, and therefore, sintering of the alloy powder 1 is further accelerated. Accordingly, in the three-dimensional printed object, the density is further increased, and also the surface roughness and the dimensional accuracy can be improved.

The average particle diameter of the powder of the carbon material 12 is 3 nm or more and 100 nm or less, and therefore, the carbon material 12 is finer than the iron alloy powder 11. Therefore, the dispersibility of the carbon material 12 with respect to the iron alloy powder 11 is improved. Accordingly, the carbon material 12 can be relatively evenly stuck or adhered to the surfaces of the iron alloy powder 11.

### 2. Second Embodiment

### 2.1. Three-Dimensional Printing Alloy Powder

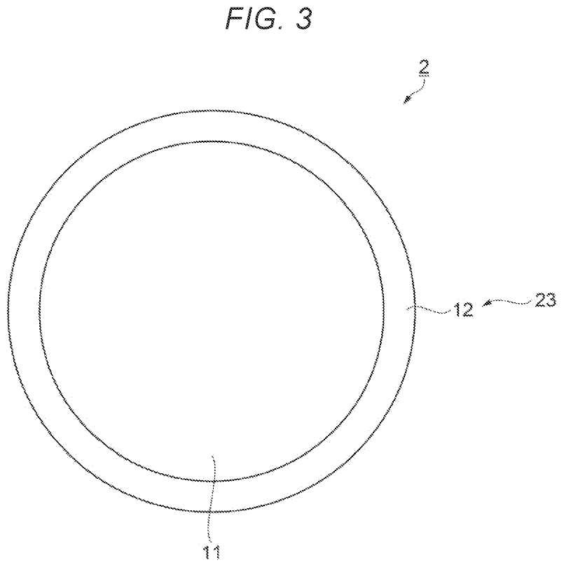

A configuration of a three-dimensional printing alloy powder according to a second embodiment will be described with reference to FIG. 3. The three-dimensional printing alloy powder of this embodiment is made different from the three-dimensional printing alloy powder 1 of the first embodiment in terms of the method for forming the coating layer. Therefore, the same reference numerals are used for the same constituent components as those of the first embodiment, and a repetitive description is omitted.

As shown in FIG. 3, a three-dimensional printing alloy powder 2 of this embodiment includes the iron alloy powder 11. At a surface of each iron alloy powder 11, a coating layer 23 containing the carbon material 12 is formed. That is, to the surface of the iron alloy powder 11, the plurality of carbon materials 12 are stuck, and the surface is coated with the coating layer 23. In the three-dimensional printing alloy powder 2, the same carbon material 12 as that of the coating layer 13 of the first embodiment is used, but the method for forming the coating layer 23 is different from that of the first embodiment. Therefore, the carbon material 12 is stuck to the surface of the iron alloy powder 11 and forms the coating layer 23 that is denser than the coating layer 13 of the first embodiment. Note that in the following description, the three-dimensional printing alloy powder 2 is sometimes simply referred to as “alloy powder 2”.

### 2.2. Method for Forming Coating Layer

A production method for the alloy powder 2 includes Step S1 and Step S2 in the same manner as in FIG. 2 of the first embodiment. In the production method for the alloy powder 2, a method for forming the coating layer 23 corresponding to Step S2 will be described. In the production method for the alloy powder 2, the production of the iron alloy powder 11 corresponding to Step S1 is performed in the same manner as in the first embodiment.

The coating layer 23 is formed by sticking a powder of the carbon material 12 to the surfaces of the iron alloy powder 11 by a mechanical method. The mechanical method refers to a method of allowing a compressive force, a frictional force, or a shearing force as physical stress to act on the carbon material 12 and the iron alloy powder 11. Examples of an apparatus to be used for the mechanical method include various types of pulverizers such as a hammer mill, a disk mill, a roller mill, a ball mill, a planetary mill, and a jet mill, Angmill (registered trademark), a high-speed oval mixer, Mix Muller (registered trademark), a Jacobson mill, Mechanofusion (registered trademark), and Hybridization (registered trademark).

When forming the coating layer 23, heat is sometimes generated by interparticle friction of the iron alloy powder s 11 and the carbon material 12. Therefore, the formation of the coating layer 23 is preferably performed in an inert gas atmosphere.

According to this embodiment, the following effect can be obtained in addition to the effects of the first embodiment.

By physical stress due to a mechanical method, the carbon material 12 is stuck to the surfaces of the iron alloy powder 11, and the coating layer 23 that is denser and firmer is formed. Therefore, occurrence of fall-off of the carbon material 12 from the surfaces of the iron alloy powder 11 is suppressed, and the reduction action of the carbon material 12 can be further enhanced.

What is claimed is:

1. A three-dimensional printing alloy powder, comprising iron alloy powder, wherein
a coating layer containing a carbon material is formed at surfaces of the iron alloy powder,
the iron alloy powder contain oxygen atoms at a concentration of 0.1 mass % or more and 0.7 mass % or less with respect to the total amount of the iron alloy powder,
a mass y g of the carbon material contained per 100 g of the three-dimensional printing alloy powder has a relationship with a mass x g of the oxygen atoms and a corrected mass z g represented by the following formula: y=0.75×x−z, and
the corrected mass z exceeds 0.0 g and is smaller than 0.4 g.

2. The three-dimensional printing alloy powder according to claim 1, wherein the corrected mass z exceeds 0.00 g and is smaller than 0.05 g.

3. The three-dimensional printing alloy powder according to claim 1, wherein the iron alloy powder have an average particle diameter of 0.1 μm or more and 20.0 μm or less.

4. The three-dimensional printing alloy powder according to claim 1, wherein the coating layer is formed by sticking a powder of the carbon material to the surfaces of the iron alloy powder by a mechanical method.

5. The three-dimensional printing alloy powder according to claim 1, wherein the powder of the carbon material has an average particle diameter of 3 nm or more and 100 nm or less.
